(19) United States
(12) Patent Application Publication
(10) Pub. No.: US 2018/0262502 A1
(43) Pub. Date: Sep. 13, 2018

(54) METHOD FOR OPERATING AN INDUSTRIAL NETWORK AND INDUSTRIAL NETWORK

(71) Applicant: SIEMENS AKTIENGESELLSCHAFT, München (DE)

(72) Inventors: Reinhard Frank, München (DE); Florian Zeiger, Höhenkirchen-Siegertsbrunn (DE)

(21) Appl. No.: 15/758,578

(22) PCT Filed: Sep. 8, 2015
(86) PCT No.: PCT/EP2015/070506

§ 371 Date: Mar. 8, 2018

(51) Int. Cl. H04L 29/06

(52) U.S. Cl. CPC H04L 63/0884; H04L 63/105; H04L 63/108; H04L 63/102

(57) ABSTRACT

The invention relates to a method (300) for operating an industrial network (100). The industrial network (100) has at least one network device (101), which can be actuated by a central control device (103), and a local interface (102) for locally accessing (A) the network device (101). The method has the following steps: transmitting (301) an access request (Q) for locally accessing (A) the network device (101) via the local interface (A) to the central control device (103); authenticating (302) the access request (Q) by means of the central control device (103); and setting up (304) the local interface (102) by means of the central control device in order to locally access (A) the network device (101) on the basis of the access request (Q). The invention further relates to a corresponding industrial network. By using the proposed method and the proposed industrial network, access to the network device can be configured more efficiently and without loss. Furthermore, the security of the industrial network is increased.

This application is the National Stage of International Application No. PCT/EP2015/070506, filed Sep. 8, 2015. The entire contents of this document is hereby incorporated herein by reference.

### BACKGROUND

The present embodiments relate to a method for operating an industrial network, and to an industrial network.

For maintenance work in industrial installations (e.g., wind farms), a remote service solution is usually employed. Accordingly, a maintenance engineer logs into an industrial network (e.g., industrial control network) of the installation to be maintained. The access rights to the industrial network are granted and monitored by a central control station. The logging into the industrial network by the engineer, the authentication of the engineer's access, and the monitoring of the engineer in the industrial network are effected by the central control station that is associated with high technical complexity.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved method for operating a network is provided.

A method for operating an industrial network is provided. The industrial network includes at least one network device that is drivable by a central control device. The industrial network also includes a local interface for a local access to the network device. The local access to the network device may be realized via the local interface.

The method includes communicating an access request for the local access to the network device via the local interface to the central control device. The method also includes authenticating the access request by the central control device, and using the central control device, setting up the local interface for the local access to the network device depending on the access request.

The industrial network concerns, for example, any type of industrial communication networks (e.g., a production installation having production cells, a wind farm, or a part thereof). By way of example, the industrial network is an operator network of a power supply grid, and the network devices are individual generators (e.g., wind turbines) in this network. The industrial network may also include a traffic network and/or a supply network of resources (e.g., electricity, oil, water, natural gas, foodstuffs, or heat).

For example, the industrial network includes a plurality of network devices. The network devices of the industrial network may concern individual modules (e.g., production modules, control units or field devices) in road traffic and/or in a supply network. For example, the network devices may operate at least partly in an automated manner (e.g., the network devices require no or only a reduced human intervention for their operation). In one embodiment, the network devices are at least partly coupled to one another, such that transport of data, material, products, and/or resources (e.g., electricity or energy) from and to one another is possible.

The industrial network includes at least one central control device that may centrally control the network devices of the industrial network. For example, the central control device is configured to communicate and/or to interact with the network devices (e.g., to interrogate data from the network devices and/or to input data or commands into the network devices).

For example, the industrial network may extend over a region that is dimensioned such that geographical distances between the individual network devices are up to tens of thousands of kilometers. The industrial network may include a backbone line, from which a plurality of branch connections proceed to the individual network devices and couple the network devices to the industrial network. Other network topologies, such as bus, ring or star topologies, may also be provided. Alternatively or additionally, the network may be coupled to a wide area network (WAN) and/or the Internet.

For maintenance work on one or more network devices, access to the corresponding network device may be allowed for service personnel (e.g., engineer, operator, administrator or mechanic) The industrial network may be protected from access by unauthorized persons. In one embodiment, the industrial network is a closed, private communication network. For this purpose, the industrial network may be configured at least partly as a corporate network that internetworks spatially remote individual networks of a corporation and links the networks to the Internet, for example, via a common firewall. The access to the industrial network may be encrypted and/or require authentication. The central control device may also be configured for monitoring accesses to the network devices. The service personnel may request a local access to the network device, for example, from the central control device.

For example, the local access to the network device is effected via and/or with the aid of the local interface assigned and connected to one or more network devices. The local interface may be connected to the assigned network device via a local area network (LAN), wireless LAN, mobile radio, and/or cable connections. The local interface may include a physical and/or virtual interface (e.g., a machine interface, a hardware interface, a network interface, a data interface, a software interface, or a combination thereof).

The physical interface provides a physical connection to which an access device (e.g., a computer, a laptop or some other device capable of computation) may be connected in order to access the network device. In one embodiment, the local interface may provide an access device, or the access device may be present in a manner integrated into the local interface.

The physical interface may include a network connection, via which components of the industrial network may be connected to the network device. For example, the physical interface may also be configured for converting between different communication protocols in order to enable a communication between the network device and different network components and/or the access device.

A virtual interface may be an interface between programs, applications, and/or operating systems in order to enable an interaction between the programs, applications, and/or operating systems of the network device, the access device, and/or network components.

For example, the local interface enables a data interrogation of the assigned network device and/or an input of data or commands into the assigned network device. The local interface may be equipped with a computing power in order, for example, to process data and to operate the assigned network device. The local interface may have a storage capacity in order, for example, to store access configurations, applications, or user specifications. The local interface may be regarded as an access point.

The access request for the local access to the network device indicates, for example, the network device that is intended to be accessed, and/or an identity of the service personnel requesting the local access to the network device.

The access request may be communicated to the central control device, for example, via the line of the industrial network, via a VPN connection, or via mobile radio. The central control device receives the access request and evaluates the access request. The authentication of the access request may be dependent on the results of the evaluation of the access request by the central control device. If the access request is authenticated, the central control device may set up the local interface such that the local access to the network device is enabled in accordance with the access request.

In one embodiment, a trust level of the access request (e.g., of service personnel issuing the access request) is determined. Accordingly, the local interface may be set up in accordance with the trust level of the access request that is determined by the central control device.

As a result of setting up the local interface for the local access, the local interface is activated and provided for the local access to the network device by the service personnel. The corresponding access rights, for example, are taken into account. Setting up the local interface may include activating physical connections, starting an access device, or producing a connection between the local interface and/or the network device. Setting up the local interface may include configuring a virtual interface at the local interface. In this case, an access configuration created by the central control device (e.g., an operating system or a set of applications) may be instantiated at the local interface. Virtual sensors (e.g., for data evaluation or data aggregation) may be instantiated at the network device. Instantiating operating systems, applications, or virtual sensors may include implementing, installing, starting, rolling out, and/or activating same.

In one embodiment, the local interface is set up in an isolated manner and in a manner encapsulated such that the interface may be decomposed without residues.

The instantiating includes, for example, the respectively required configurations, applications, and communication connections that are realized by virtual components. Consequently, such an access is intrinsically encapsulated. If a plurality of different accesses are active simultaneously, the different accesses therefore do not influence one another.

The applications may be used, for example, for data interrogation and data input or for controlling the network device. The applications may include a terminal or a maintenance program for interaction with the network device.

In one embodiment, data (e.g., applications, programs, or operating systems) for setting up the local interface may be present in a manner stored or installed at the local interface or at the access device.

Setting up the local interface may involve generating a virtual network and/or instantiating virtual network functions for the virtual network. Various network configuration technologies (e.g., VPN, forming tunnels between network components or software defined networking (SDN)) may be employed here.

The virtual network may be adapted to the access request. The virtual network is, for example, a virtual overlay network based on an existing network (e.g., industrial network, a WAN, or the Internet). The existing network, for example, uses parts of structures of the existing network in order to transport data.

The virtual network functions may include, for example, control of the data traffic (e.g., traffic shaping), a firewall, switching, data traffic routing, or ports monitoring. For example, a virtual firewall may be instantiated at the local interface in order to restrict and/or filter the local access. In one embodiment, the virtual firewall is an industrial firewall specifically for protecting industrial networks.

The local interface may be set up, for example, such that the local access to the network device satisfies specific connection requirements (e.g., specifications in accordance with quality of service (QoS) for the industrial network). The QoS may stipulate minimum requirements with respect to a quality and/or a grade of the connection and data transmission in an industrial network. By way of example, the QoS concerns a speed, latencies, a jitter, or a reliability of the connection and/or data transmission. The QoS may concern a frequency of disturbances, transmission errors, connection errors, and/or connection problems.

In accordance with one embodiment, the local access to the network device is temporally limited.

The access request may include an expected duration of the local access to the network device. The access duration may be defined by the central control device, requested with the access request, or defined in a general manner A predefined access duration may be stored at the central control device or at the local interface, and the access duration may be defined automatically. An indication of the access duration may include a start time, an end time, and/or a time interval of the local access to the network device.

Temporally limiting the local access makes it possible to preclude an undesired access to the industrial network after the access duration has elapsed. The security of the industrial network may thus be increased.

In accordance with a further embodiment, the method furthermore includes deactivating the local interface after the local access to the network device has ended.

As a result, an unnecessary continuance of a possibility of access to the network device and/or the industrial network after the end of the local access is prevented and a security risk is eliminated.

Deactivating the local interface may include, for example, deactivating components that are instantiated or generated at the local interface. The components concern, for example, the virtual network, the virtual network functions, the applications, and/or the operating systems. Deactivating may include closing, deleting, uninstalling, stopping, terminating, canceling, removing, or eliminating the corresponding component.

In accordance with a further embodiment, the local access to the network device is effected with the aid of an access device that is coupled to the local interface. An access data set for enabling the local access to the network device via the local interface is provided at the access device if the access request is authenticated by the central control device.

In one embodiment, the access data set contains information about the trust level of the local access and/or of the service personnel to which/whom the access data set is assigned. The access data set may be personalized (e.g., adapted to service personnel issuing the access request) and/or be valid only for the service personnel. The local access to the network device may be provided, for example, by creating an account (e.g., access account) that the service personnel may use to log into the industrial network. Accordingly, the access data set may contain account data (e.g., a user identification and a key) for logging into the network device and/or the industrial network.

The access data set may be created by the central control device depending on results of the evaluation of the access request. The access data set may be present in a manner prestored at the central control device and may be output after an authentication of the access request. The access data set may include a time duration within which the access to the network device is granted. The access data set may be transmitted in an encrypted manner

In one embodiment, the local interface may be set up for the local access to the network device if the service personnel input the access data set into the local interface or into an access device connected to the local interface.

In accordance with a further embodiment, the method also includes generating a virtual network. The virtual network of the industrial network is then part of the industrial network and includes at least the network device to which the access request is directed. In this case, the central control device is segregated from the virtual network (e.g., is not part of the virtual network used by the access device for the local access to the at least one network device).

By way of example, overlay networks are appropriate as a virtual network. Protocol-based networks such as VLANs, VPN, VPLS or the like and software-defined networks (SDN) may be provided.

As a result, an encapsulated network, in which access to the local interface and to the assigned network device is limited, may be generated. A security risk for the industrial network may thus be lowered.

Data transport between the service personnel and the network device is not effected via the central control device with the result that it is possible to achieve an improved connection quality on account of shorter latencies or smaller fluctuations.

In accordance with a further embodiment, the method also includes communicating access specifications of the access request to the central control device. In this case, the access specifications include an identifier of an access device, an identity of service personnel, a connection type of the local access, connection requirements of the local access, an access duration, and/or resources provided for the local access. The method also includes setting up the interface for the local access to the network device in accordance with the access specifications.

For example, the access specifications may define a bandwidth and/or a computing power for the local access to the network device. For the case where a plurality of local accesses to the network device take place simultaneously, a division of resources (e.g., of the bandwidth and of the computing power at the local interface and network device; with the aid of prioritization of connections) may be defined and managed

The connection requirements may be determined, for example, by standards (e.g., quality of service of a communication service). The connection requirements may correspond to predefined standards (e.g., IEEE 802.1p).

In accordance with a further embodiment, setting up the local interface includes instantiating applications at the local interface.

The applications include, for example, applications that are used during the local access to the network device. The applications may include virtual sensors that are instantiated at the network device. The applications may be instantiated at the access device connected to the local interface.

In accordance with a further embodiment, setting up the local interface is effected with the aid of templates that are present in a manner stored at the central control device.

The templates may include components or parts of data or information relevant to setting up the local interface for the access to the network device. By way of example, the templates include information about the trust level, access type, access duration, connection requirements, access device, and/or resource distribution. For example, the templates may at least partly contain access specifications for the access to the network device.

In accordance with a further embodiment, communicating the access request to the central control device is effected in an encrypted manner Additionally or alternatively, setting up the local interface by the central control device is effected in an encrypted manner

As a result, the security of the industrial network may be increased further. For example, an attack from outside may be better repelled.

In accordance with a further embodiment, the local access to the network device is effected for the purpose of maintaining, checking, monitoring, modifying, operating, repairing, switching on, switching off, driving the network device, and/or for the purpose of locally retrieving data from the network device.

The service personnel may carry out the local access for one of the purposes mentioned above. For example, technical work is carried out on the assigned network device.

In accordance with a further embodiment, the local access to the network device is effected via a local area network (LAN) and/or with the aid of Wireless LAN, Bluetooth, mobile radio technologies, LTE-based connections and/or in a wired manner

As a result, a connection quality during the local access to the network device may be improved. In addition, a short data transmission path may further improve the connection quality.

In accordance with a further embodiment, the industrial network includes a plurality of network devices. In this case, the access request includes a local access to a subnetwork of a plurality of network devices of the industrial network, where the local access is effected via the local interface.

The above-described features of the method may also be applied to a local access to a subnetwork of the industrial network. The subnetwork of network devices may be a grouping of network devices that are geographically close together. For example, the subnetwork may correspond to one location of a plurality of locations of the industrial network. A subnetwork may be defined, for example, by the functionalities of the network devices (e.g., controllers for field devices in automation networks).

The subnetwork may include a defined subset of network devices of the industrial network. The subnetwork may be embodied in the form of a virtual network. A local interface of a subnetwork may be connected to each of the network devices of the subnetwork and enable a local access to each of the network devices.

In accordance with a further embodiment, the local access to the network device has a smaller data transmission path than a data transmission path for driving the network device by the central control device.

For example, a geographical distance between the network device and the central control device is greater than a geographical distance between the network device and the local interface. A shorter data transmission path may reduce latencies during the data transmission and/or reduce undesired fluctuations (e.g., jitter). By way of example, the connection quality may be improved in this way. The method makes it possible, for example, that the guarantees concerning the connection quality that are required for a respective application mayn be realized.

In one embodiment, a local interface is allocated in a planned manner and corresponding resources, for example of an underlying network infrastructure, are provided. As a result, specific connection qualities over the period for which the local interface exists may be guarantted.

In accordance with a second aspect, an industrial network is provided. The industrial network includes at least one network device that is drivable by a central control device. The industrial network includes a local interface for the local access to the network device. The industrial network is suitable for performing the method described above.

For example, the industrial network includes a plurality of network devices. All of the features proposed above for the method for operating an industrial network may also be correspondingly applied to the proposed industrial network.

In accordance with one embodiment, the industrial network is provided at least partly in the form of a virtual personal network (VPN) in a network.

For example, data transport in the industrial network is effected at least partly via a wide area network (WAN) or the Internet, which are used as a transmission path for the industrial network. Additionally or alternatively, the industrial network may include a backbone line or radio connection for transmitting data.

The method and the industrial network of the present embodiments enable, for example, a local access to the network device with support of industrial quality of service requirements. Complex routing of connections over long geographical distances is not required. The local access may be provided temporarily. By deactivating the local access, connections, and/or functions that are possibly defective or beset by security risks may be eliminated. As a result, an increased security for the industrial network may be achieved.

Network resources (e.g., bandwidth or computational capacities) may be organized and requested in a demand-oriented manner A monitoring complexity with respect to accesses to the network devices of the industrial network may likewise be reduced.

The respective unit (e.g., the access device, the local interface, or the central control device) may be implemented in terms of hardware and/or in terms of software. In the case of an implementation in terms of hardware, the respective unit may be embodied as an apparatus or as part of an apparatus (e.g., as a computer or as a microprocessor or as a control computer of a vehicle). In the case of an implementation in terms of software, the respective unit may be embodied as a computer program product, as a function, as a routine, as part of a program code, or as an executable object.

A computer program product that causes the method explained above to be carried out on a program-controlled device, such as elements of the network, for example, is provided. A respective program-controlled device may be either software- or hardware-based. In one embodiment, the access device may, for example, be implemented as a downloadable or short-time installable or activatable access application on a smart phone.

A computer program product such as, for example, a computer program device may be provided or supplied, for example, as a storage medium, such as, for example, a memory card, USB stick, CD-ROM, DVD, or else in the form of a downloadable file from a server in a network. This may be effected, for example, in a wireless communication network by the transmission of a corresponding file with the computer program product or the computer program device.

The embodiments and features described for the method are correspondingly applicable to the industrial network.

Further possible implementations also include combinations, not explicitly mentioned, of features or embodiments described above or below with regard to the exemplary embodiments. In this case, the person skilled in the art will also add individual aspects as improvements or supplementations to the respective basic form of the invention.

### BRIEF DESCRIPTION OF THE DRAWINGS

FIG. 1 shows a schematic view of a first embodiment of an industrial network with an access device;

FIG. 2 shows a schematic view of a second embodiment of an industrial network with the access device;

FIG. 3 shows a sequence diagram of one embodiment of a method for operating an industrial network;

FIG. 4 shows a schematic view of a third embodiment of an industrial network with the access device;

FIG. 5 shows a schematic view of a fourth embodiment of an industrial network with the access device; and

FIG. 6 shows a schematic view of a fifth embodiment of an industrial network with the access device.

### DETAILED DESCRIPTION

In the figures, same or functionally same elements have been provided by the same reference sign, unless indicated otherwise.

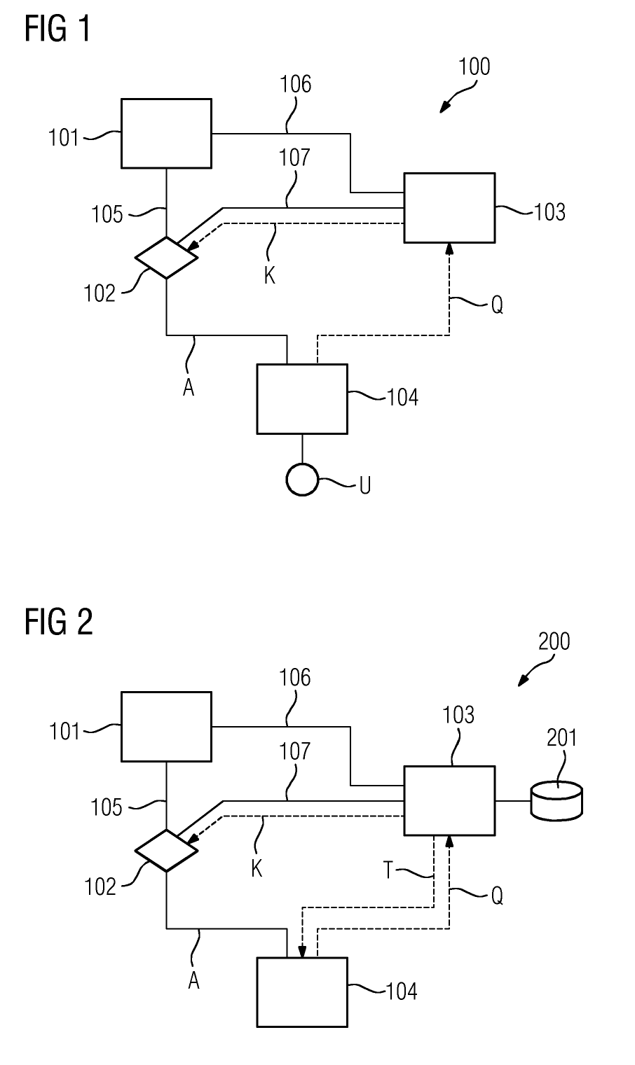

FIG. 1 shows a schematic view of a first embodiment of an industrial network 100 with an access device 104.

The industrial network 100 includes a network device 101 and a local interface 102. The local interface 102 is connected to the network device 101 via a line 105. The network device 101 and the local interface 102 are connected to a central control device 103 via a respective line 106, 107. The local interface 102 allows service personnel U, being an engineer, an operator, a mechanic, or a system administrator, to have a local access A to the network device 101.

The local interface 102 is connected to an access device 104. The access device 104 is equipped with a computing power and a storage capacity. The access device 104 is a computer, a mobile computer, or a terminal in the industrial network 100. With the aid of the access device 104, the network device 101 may be accessed via the local interface 102. The access device 104 is connected to the local interface 102 via a physical line (e.g., an Ethernet cable) or in a wireless manner (e.g., via W-LAN, or by mobile radio; via an LTE-Advanced connection).

An access request Q is sent to the central control device 103 by the service personnel U via the access device 104. The control device 103 evaluates the access request Q, authenticates the access request Q, and defines a trust level of the service personnel U. The central control device 103 creates an access configuration K, in accordance with which the local interface 102 is set up for the local access A to the network device 101 by the service personnel U.

The local interface 102 is equipped, for example, with a computing power and a storage capacity in order to store and/or implement the access configuration K. The access configuration K is communicated to the local interface 102 and instantiated at the local interface 102. This involves installing and starting a set of applications at the local interface 102 and virtual sensors for detecting and processing data at the network device 101.

Consequently, the local interface 102 is set up for the local access A to the network device 101. With the aid of the applications and virtual sensors, the service personnel U may interact with the network device 101 and interrogate data from the network device 101. The local access A to the network device 101 may be effected for the purpose of maintaining, controlling, operating, operationally controlling, repairing, modifying the network device 101 or interrogating data from the network device 101.

FIG. 2 shows a schematic view of a second embodiment of an industrial network 200 with the access device 104 in FIG. 1.

The industrial network 200 has all of the features and elements and also devices of the industrial network 100 in FIG. 1. In addition, the central control device 103 is equipped with a database device 201, at which templates for setting up the local interface 102 for the local access A to the network device 101 are present in a prestored manner

The templates include both prefabricated access configurations and components for an access configuration. The templates include, for example, access specifications (e.g., connection requirements), an identifier of an access device, an identity or trust level of the service personnel U, a connection type of the local access A, an access duration, and/or resources that characterize the local access A to the network device 101.

By way of example, the industrial network is a power supply grid with a wind power installation as network device 101. From the central control device 103, which is a central server computer of the operator of the wind power installation 101, access to the control unit of the wind power installation 101 for 8 hours is requested by the service personnel U, being an engineer of the manufacturer of the wind power installation 101, in order to carry out a planned examination. The examination concerns, inter alia, a running power, wear, fluctuations of characteristic variables (e.g., voltage, frequency and amplitude), and correct drivability. In a further example, from the central server computer, access to the wind power installation 101 is requested by the service personnel in order to acquire statistical data (e.g., generated electrical power in the last 2 weeks).

The central control device 103 creates the access configuration K for the local access A to the network device based on the templates stored at the database device 201. Afterward, the access configuration K is communicated to the local interface 102 and instantiated at the local interface 102.

After successful authentication of the access request Q, the central control device 103 creates an access data set T in the form of an access token in accordance with the trust level of the service personnel U. The access token T contains a user identifier and a password for logging into the industrial network 200 and also an access duration (e.g., 24 hours or 7 days), within which the local access A is allowed. The access request Q and the access token T are communicated in an encrypted (e.g., private) connection (e.g., via the Internet as a VPN connection).

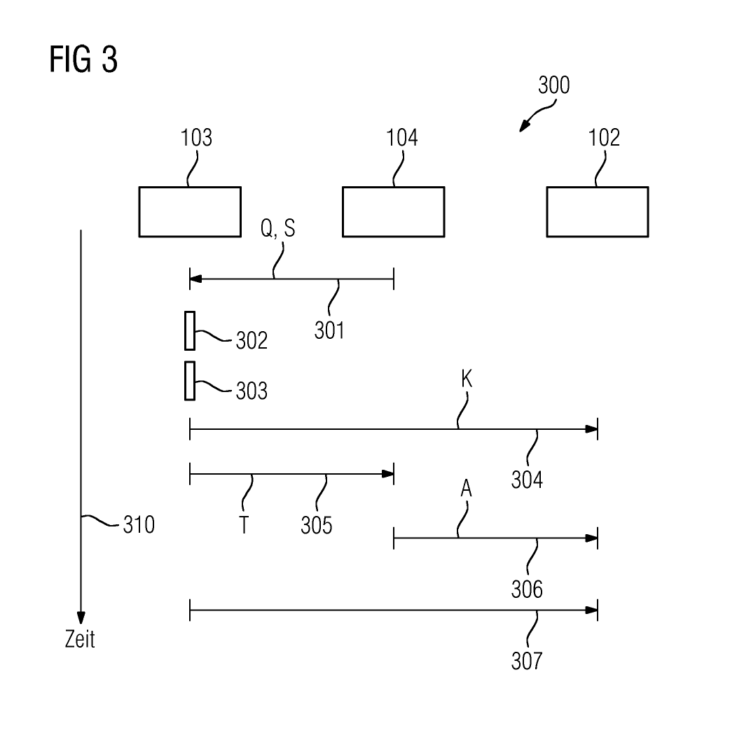

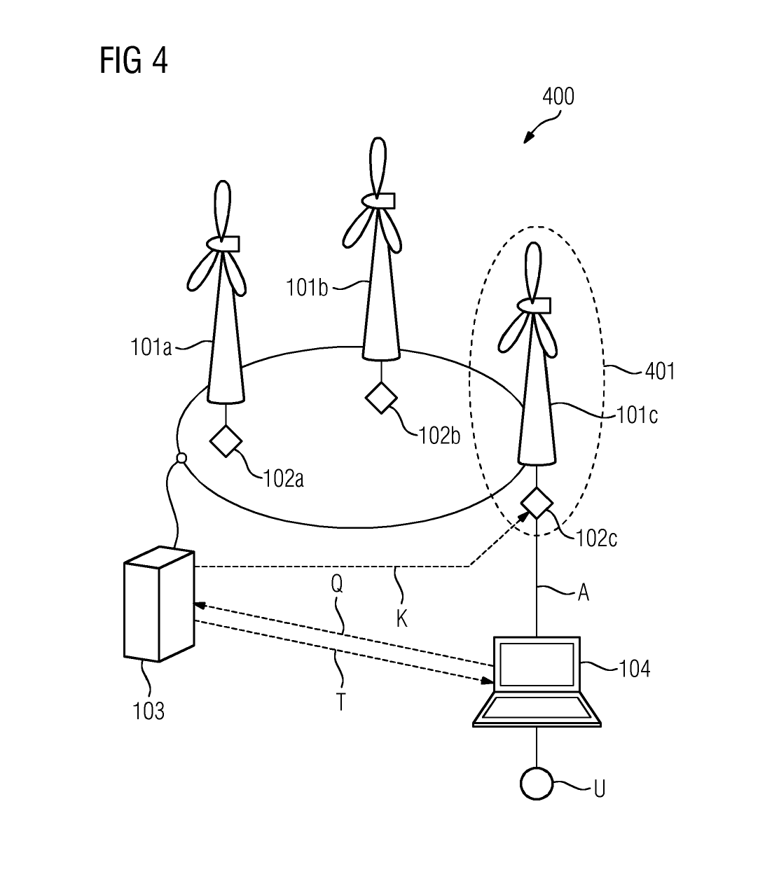

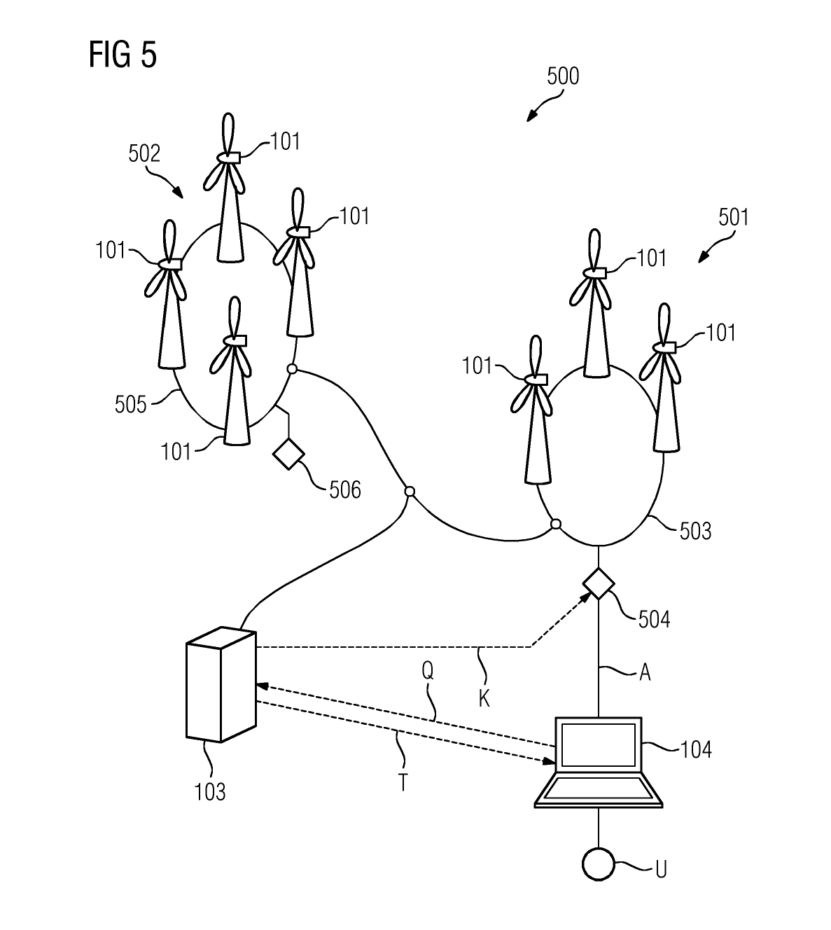

FIG. 3 shows a sequence diagram of one embodiment of a method 300 for operating an industrial network. For example, the method 300 in FIG. 3 is suitable for operating the industrial networks 100, 200 in FIGS. 1 and 2. The method 300 shown in FIG. 3 is suitable for operating industrial networks that are illustrated in FIGS. 4 to 6 and are explained below.

In FIG. 3, the central control device 103, the access device 104, and the local interface 102 are illustrated symbolically in a horizontal series alongside one another. A vertical time axis 310 shows a temporal progression of the method 300.

In a first act 301, the access request Q is communicated by the access device 104 or the service personnel U to the central control device 103. In this case, the access request Q may contain the requested access specifications S.

In a next act 302, the access request Q is authenticated by the central control device 103. For example, the access specifications S are evaluated. If appropriate, prestored templates (e.g., at the database 201 in FIG. 2) that correspond to the access request or to the access specifications are ascertained. Optionally, a trust level of the service personnel U is also defined.

After a successful authentication of the access request Q, in a next act 303, the central control device 103 creates the access configuration K for setting up the local interface 102 for the local access A to the network device 101. Optionally, the central control device 103 also creates the access data set T for the service personnel U. The central control device 103 also optionally creates an access account at the local interface 102 or at the access device 104, using which access account the service personnel U may log into the network device 101 or the industrial network 100, 200. The access device is a computer or a terminal connected to or integrated into the local interface 102.

In a next act 304, the access configuration K is communicated by the central control device 103 to the local interface 102 and instantiated at the central control device 103. In this way, the local interface 102 is set up for a local access A to the network device 101. The access configuration K is communicated in an encrypted manner and via a private connection (e.g., via the Internet as a VPN connection).

In a further act 305, the access token T is provided to the service personnel U. The access token T may be conveyed to the service personnel directly (e.g., via mobile radio or a VPN connection) or may be provided at the local interface 102 and/or at the access device 104. In this case, the access token T is communicated in an encrypted manner The access token T also optionally contains access account data (e.g., a user identifier and a password) for logging into the network device 101 or the industrial network 100, 200 using the access account.

In a further act 306, the local access A to the network device 101 is effected from the access device 104 via the local interface 102. The local access A enables, for example, maintenance work, service services, or data interrogations at the network device 101.

In act 307, the local interface 102 is closed and blocked for the local access A. Optionally, the access data set T is also deleted and deactivated, such that the access data set T is no longer valid.

The industrial network and the method are illustrated below based on examples of wind power installations and wind farms. The examples shown in FIGS. 4 to 6 have all of the features of the industrial network 100 shown in FIG. 1 and of the method for operating the industrial network 100 explained with the aid of FIG. 1.

FIG. 4 shows a schematic view of a third embodiment of an industrial network 400 with the access device 104.

The industrial network 400 includes a wind farm including wind power installations 101a to 101c. The wind power installations 101a-101c are connected to a respective local interface 102a-102b that enables a local access to the assigned wind power installation 101a-101c.

The central control device 103 is embodied as a server computer having a computing power and storage capacity. The access device 104 is a mobile computer that may be connected to the local interfaces 102a-102c.

FIG. 4 shows a local access A to the network device 101c from the mobile computer 104 via the local interface 102c. From the mobile computer 104, an access request Q is communicated to the server computer 103. The server computer 103 evaluates the access request Q. After successful authentication of the access request Q, an access data set T is created and communicated to the mobile computer 104. The server computer 103 defines the access configuration K, which is communicated to the local interface 102c and instantiated at the local interface 102c.

The mobile computer 104 is connected to the local interface 102c by the service personnel U. The service personnel U use the access data set T on the mobile computer 104 to log into the industrial network 400. An operating system and various applications that are predefined by the access configuration K and are required for the local access are started on the mobile computer. A virtual sensor for detecting power characteristic curves at the wind power installation 101c is instantiated.

The access configuration K is embodied, for example, such that the local access using the access data set T is limited to the local interface 102c and the assigned wind power installation 101c. For this purpose, a virtual network 401 is generated, which includes only part of the industrial network 400 and prevents access to further network devices 101a, 101b by the service personnel.

Virtual network functions for the virtual network 401 are instantiated at the local interface. Network configuration technologies such as VPN, forming tunnels between network components and SDN, are employed for setting up the virtual network 401. A VPN-based connection is effected via a WAN or the Internet, without being accessible to unauthorized persons. The tunnel allows two or more subscribers of the industrial network to communicate with one another via a connection (e.g., Internet) that uses a different communication protocol than the industrial network. SDN technology enables a software-based configuration and structuring of the industrial network (e.g., of virtual networks within the industrial network) by the central control device.

The virtual network functions include a targeted control of the data traffic between the mobile computer 104 and the wind power installation 101a, a limitation of the data traffic between the mobile computer 104 and other wind power installations 101b, 101c of the industrial network 400, and a blocking of the other connections in order to prevent unauthorized accesses to the network devices 101a-101c or to the industrial network 400. A virtual industrial firewall between the Internet and the industrial network 400 and also the virtual network 401 is instantiated in order to prevent an unauthorized access from the Internet.

FIG. 5 shows a schematic view of a fourth embodiment of an industrial network 500 with the mobile computer 104 as access device.

The industrial network 500 includes a plurality of wind power installations 101 as network devices. FIG. 5 shows the wind power installations 101 at two locations 501, 502. The wind power installations 101 at a first location 501 are combined to form a first subnetwork 503. The first subnetwork 503 is connected to a first interface 504 that enables access to the first subnetwork 503 and also to the network devices 101 of the first subnetwork 503. The wind power installations 101 at a second location 502 are analogously combined to form a second subnetwork 505, where the second subnetwork 505 is connected to a second interface 506, via which access to the wind power installations 101 of the subnetwork 506 is possible.

The network configuration technologies VPN, tunnel, and SDN, for example, are employed for setting up the subnetworks 503, 505 within the industrial network 500.

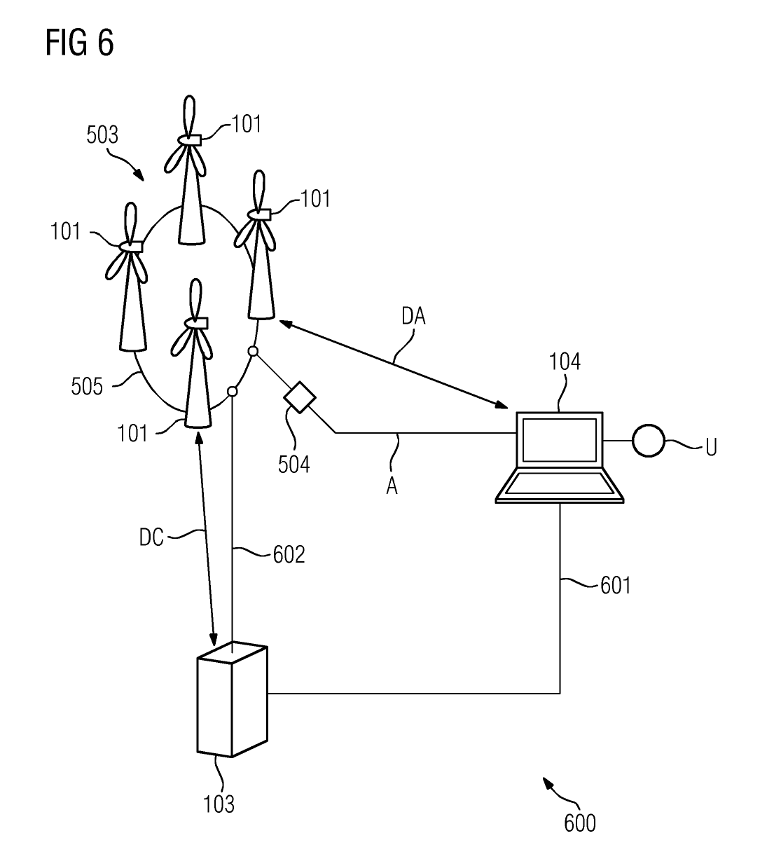

FIG. 6 shows a schematic view of a fifth embodiment of an industrial network 600 with the mobile computer 104 as access device. For example, the industrial network 600 includes the wind power installations 101 of the first subnetwork 503 in FIG. 5.

FIG. 6 shows a local access A to the second subnetwork 503 of network devices 101 via the local interface 504. A geographical distance DA between the first subnetwork 503 and the mobile computer 104 is from a few centimeters to hundreds of meters. A geographical distance DC between the first subnetwork 503 and the server computer 103 is from a few kilometers to a few thousand kilometers. The access A to the first subnetwork 503 is effected without routing via the server computer 103, such that latencies during data transmission are shortened and a packet loss and fluctuations (e.g., jitter) are reduced. Overall, the connection quality is thus improved.

The server computer is connected to the mobile computer 104 via a connection 601 and to the first subnetwork 503 via a connection 602. In this case, the connections 601, 602 are partly produced via the Internet. For example, the connection 601 constitutes a coupling formed by an authentication, and the connection 602 may be a protected connection (e.g., in the manner of a dedicated line). Alternatively or additionally, the connections 601, 602 may at least partly include an electrical, optical, or electromagnetic line. In one embodiment, the connection via the interface 504 may be a VPN connection. The central server computer 103 is linked into the network such that it is possible for the interface 504 to be set up.

The industrial networks 100, 200, 400, 500, 600 described above may be set up such that a connection and data transmission within the industrial network satisfy predefined requirements (e.g., a quality of service or standards such as IEEE 802.1p). By the direct and local access to the network devices, the connection quality may be improved by comparison with routing via the central control device of the industrial network).

The encapsulation of the local access by the service personnel U increases the security of the respective industrial network. The local access may be temporally limited in order to preclude unnecessary access possibilities with respect to the industrial network.

Although the present invention has been described based on wind farms, the present invention is applicable in diverse ways (e.g., to production installations, other supply networks such as electricity, heat, water, oil or gas supply networks, traffic networks or communication networks).

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for operating an industrial network, the industrial network comprising at least one network device that is drivable by a central control device, and a local interface for a local access to the at least one network device, the method comprising:
communicating an access request for the local access to a network device of the at least one network device via the local interface to the central control device;
authenticating, by the central control device, the access request; and
setting up, by the central control device, the local interface for the local access to the network device depending on the access request.

2. The method of claim 1, wherein the local access to the network device is temporally limited.

3. The method as claimed in of claim 1, further comprising deactivating the local interface after the local access to the network device has ended.

4. The method of claim 1, wherein the local access to the network device is effected with the aid of an access device, which that is coupled to the local interface, and
wherein an access data set for enabling the local access to the network device via the local interface is provided at the access device if when the access request is authenticated.

5. The method of claim 1, further comprising generating a virtual network, that is part of the industrial network, the virtual network comprising at least the network device, to which the access request is directed,
wherein the central control device is not part of the virtual network.

6. The method of claim 1, further comprising communicating access specifications of the access request to the central control device, wherein the access specifications comprise an identifier of an access device, an identity of service personnel, a connection type of the local access, connection requirements of the local access, an access duration, resources provided for the local access, or any combination thereof, and
wherein setting up the local interface for the local access to the network device comprises setting up the local interface for the local access to the network device in accordance with the access specifications.

7. The method of claim 1, wherein setting up the local interface for the local access to the network device comprises instantiating applications at the local interface.

8. The method of claim 1, wherein setting up the local interface is effected with the aid of templates stored at the central control device.

9. The method of claim 1, wherein communicating the access request to the central control device, setting up the local interface by the central control device, or a combination thereof effected in an encrypted manner.

10. The method of claim 1, wherein the local access to the network device is effected for the purpose of maintaining, checking, monitoring, modifying, operating, repairing, switching on, switching off, driving the network device, for the purpose of locally retrieving data from the network device, or any combination thereof.

11. The method of claim 1, wherein the local access to the network device -is effected via a local area network, with the aid of Wireless LAN, Bluetooth, mobile radio technologies, LTE-based connections, in a wired manner, or any combination thereof, or via the local area network and with the aid of Wireless LAN, Bluetooth, mobile radio technologies, LTE-based connections, in a wired manner, or the combination thereof.

12. The method of claim 1, wherein the industrial network comprises a plurality of network devices, and the access request comprises a local access to a subnetwork of a plurality of network devices via the respective local interface.

13. The method of claim 1, wherein the local access to the network device has a smaller data transmission path than a data transmission path for driving the network device by the central control device.

14. An industrial network comprising:
at least one network device that is drivable by a central control device; and
a local interface for the local access to the at least one network device, an access request for the local access to a network device of the at least one network device being communicatable via the local interface to the central control device,
wherein the central control device is configured to:
authenticate the access request; and
set up the local interface for the local access to the network device depending on the access request.

15. The industrial network of claim 14, wherein the industrial network is provided at least partly in the form of a virtual network in a network.
